(19) United States
(12) Patent Application Publication
(10) Pub. No.: US 2006/0227097 A1
(43) Pub. Date: Oct. 12, 2006

(54) Electrophoretic active matrix display device

(75) Inventors: Guofu Zhou, Eindhoven (NL); Franciscus Johannes Antonius Maria Greidanus, Eindhoven (NL); Mark Thomas Johnson, Eindhoven (NL); Alexander Victor Henzen, Heerlen (NL); Willibrordus Jurrianus Dijkman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/546,310

(22) PCT Filed: Feb. 18, 2004
(86) PCT No.: PCT/IB04/50122

§ 371 Date: Aug. 19, 2005

(30) Foreign Application Priority Data
Feb. 27, 2003 (EP) 03100491.4

(51) Int. Cl. G09G 3/34

(52) U.S. Cl. 345/107

(57) ABSTRACT

The invention relates to an apparatus for displaying data on a display, the apparatus comprising an electrophoretic display device, a storage device, user input means and a central processing unit conceived to retrieve data from the storage device and send the retrieved data to the display device for display. Advantageously, the storage device is a disk drive for reading data from removable optical disks with a diameter between 25 millimeter and 50 millimeter. The apparatus can be used as an electronic book.

The invention relates to an apparatus for displaying data on a display, the apparatus comprising an electrophoretic display device.

Electrophoretic displays are known from international patent application WO 99/53373. This patent application discloses an electronic ink display comprising two substrates, one of which is transparent, and the other is provided with electrodes arranged in row and columns. A crossing between a row and a column electrode is associated with a display element. The display element is coupled to the column electrode via a thin-film transistor (TFT), the gate of which is coupled to the row electrode. This arrangement of display elements, TFT transistors and row and column electrodes together forms an active matrix. Furthermore, the display element comprises a pixel electrode. A row driver selects a row of display elements and the column driver supplies a data signal to the selected row of display elements via the column electrodes and the TFT transistors. The data signal corresponds to graphic data to be displayed.

Furthermore, an electronic ink is provided between the pixel electrode and a common electrode provided on the transparent substrate. The electronic ink comprises multiple microcapsules of about 10 to 50 microns. Each microcapsule comprises positively charged white particles and negatively charged black particles suspended in a fluid. When a negative field is applied to the common electrode, the white particles move to the side of the microcapsule directed to the transparent substrate, and the display element becomes visible to a viewer. Simultaneously, the black particles move to the pixel electrode at the opposite side of the microcapsule where they are hidden from the viewer. By applying a positive field to the common electrode, the black particles move to the common electrode at the side of the microcapsule directed to the transparent substrate, and the display element appears dark to a viewer. When the electric field is removed, the display device remains in the acquired state and exhibits a bi-stable character.

Grey scales can be created in the display device by controlling the amount of particles that move to the counter electrode at the top of the microcapsules. For example, the energy of the positive or negative electric field, defined as the product of field strength and time of application, controls the amount of particles moving to the top of the microcapsules.

The known display devices have a so-called dwell time. The dwell time is defined as the interval between a previous image update and a new image update.

A disadvantage of the present display is that it exhibits an underdrive effect, which leads to inaccurate grey scale reproduction. This underdrive effect occurs, for example, when an initial state of the display device is black and the display is periodically switched between the white and the black state. For example, after a dwell time of several seconds, the display device is switched to white by applying a negative field for an interval of 200 ms. In a subsequent interval, no electric field is applied for 200 ms and the display remains white, and in a subsequent interval, a positive field is applied for 200 ms and the display is switched to black. The brightness of the display as a response of the first pulse of the series is below the desired maximum brightness, which can be reproduced several pulses later.

A disadvantage of an apparatus as mentioned in the opening paragraph is that it does not provide a storage device for storing data. This means that when the device is carried, as a portable electronic book for example, a separate storage device has to be attached to the apparatus. This hampers portability of the apparatus.

It is an object of the invention to provide an apparatus for displaying data on a display comprising an electrophoretic display device with enhanced portability. To achieve this object, a first aspect of the invention provides an apparatus as specified in claim 1.

An advantage of such a device is that all necessary components for providing a portable solution for a system for displaying data on an electrophoretic display device, the electrophoretic display device itself and the memory on which the data is stored are comprised by a single apparatus. This enhances to portability of the system and therefore the apparatus according to the invention has enhanced portability over systems provided by the prior art.

Further advantageous embodiments of the invention are specified in the dependent claims.

In an embodiment as specified in claim 3, the storage device is a disk drive for reading data from an optical disk with a diameter of 3 centimeters or less.

An advantage of such a device is that it comprises a relatively small optical disk drive. The diameter of the disk is merely a quarter of the diameter of conventional optical disks like Compact Disc® or Digital Versatile Disc®, meaning that—theoretically speaking—the surface/footprint in the apparatus consumed by the disk drive for the small optical disk is only one sixteenth of the surface/footprint of a conventional optical disk drive. Therefore, this embodiment enhances portability of the system and therefore of the apparatus even more.

In an embodiment as specified in claim 4, the display device comprises: electrophoretic particles; a display element comprising a pixel electrode; a counter electrode between which a portion of the electrophoretic particles is present, and control means for supplying a drive signal to the electrodes to bring the display element to a predetermined optical state corresponding to the image information to be displayed; and the control means are further arranged to supply a preset signal preceding the drive signal and comprising a preset pulse representing an energy which is sufficient to release the electrophoretic particles at a first position near one of the two electrodes corresponding to a first optical state, but is too low to enable the particles to reach a second position near the other electrode corresponding to a second optical state.

The embodiment as specified in claim 4 is based on the recognition that the optical response depends on the history of the display element. The inventors have observed that the underdrive effect is reduced when a preset signal is supplied before the drive signal to the pixel electrode, which preset signal comprises a pulse representing an energy which is sufficient to release the electrophoretic particle from a static state at one of the two electrodes, but is too low too reach the other one of the electrodes. Because of the reduced underdrive effect, the optical response to an identical data signal will be substantially equal, regardless of the history of the display device and in particular its dwell time. The underlying mechanism can be explained because the electrophoretic particles come in a static state, after the display device is switched to a predetermined state, e.g. a black state, and when there is a subsequent switching to the white state, a momentum of the particles is low because their starting speed is close to zero. This results in a long switching time. The application of the preset pulses increases the momentum of the electrophoretic particles and thus shortens the switching time.

A further advantage is that the application of the preset pulses substantially eliminates a prior history of the electronic ink, whereas conventional electronic ink display devices require massive signal processing circuits for generating data pulses of a new frame and storing several previous frames and a large look-up table.

Such a preset pulse can have a duration of one order of magnitude less than the time interval between two subsequent image updates. An image update is the instant when the image information of the display device is renewed or refreshed.

In an embodiment as specified in claim 6, the power dissipation of the display device can be minimized by applying just a single preset pulse.

In an embodiment as specified in claim 7, a preset signal consisting of an even number of preset pulses of opposite polarity can be generated for minimizing the DC component and the visibility of the preset pulses of the display device. Two preset pulses, one with positive polarity and one with negative polarity will minimize the power dissipation of the display device within this mode of operation.

In an embodiment as specified in claim 8, the electrodes are arranged to form a passive matrix display.

In an embodiment as specified in claim 9, the display device is provided with an active matrix addressing to supply the data signals to the pixel electrodes of the display elements.

In an embodiment as specified in claim 10, the display elements are interconnected in two or more groups wherein preset pulses having a different polarity are supplied to the different parts of the screen. For example, when in a single frame addressing period the preset pulses are applied with a positive polarity to all even rows and with a negative polarity to all odd rows, adjacent rows of the display device will appear alternately brighter and darker, and the positive and negative polarities of the preset pulses are inverted in the subsequent frame addressing period, so that the perceptual appearance will hardly be affected, as the eye integrates these short brightness fluctuations both across the display (spatial integration) and subsequent frames (temporal averaging). This principle is similar to the line inversion principle in methods of driving liquid crystal displays with reduced flicker.

In an embodiment as specified in claim 11, the preset signals are generated in the second driving means and applied to the pixel electrodes simultaneously by selecting, for example, all even rows followed by all odd rows at a time by the first driving means. This embodiment requires no additional electronics on the substrates.

In an embodiment as specified in claim 12, the preset signals are applied directly via the counter electrode to the pixel electrode. An advantage of this arrangement is that the power consumption is lower because the capacitance involved in this case is lower than in the case where the row or column electrodes are addressed.

In an embodiment as specified in claim 13, the counter electrode is divided into several portions in order to reduce the visibility of the preset pulses.

In an embodiment as specified in claim 14, the pixel electrode is coupled via a first additional capacitive element. The voltage pulses on the pixel electrode can now be defined as the ratio of a pixel capacitance and the first additional capacitive element. The pixel capacitance is the intrinsic capacitance of the material between the pixel electrode and the transparent substrate. Particularly in combination with an encapsulated electrophoretic material as supplied by E-Ink Corporation, this embodiment can be advantageous because in case the first additional capacitive element is selected to have a large value compared to the pixel capacitance, the preset signal will substantially be transmitted to the pixel electrode, which reduces the power consumption.

Furthermore, the pixel capacitance will not vary significantly with the different applied grey levels. Thus, the preset pulse on the pixel electrode will be substantially equal for all display elements, irrespective of the applied grey levels.

In an embodiment as specified in claim 15, the pixel element is coupled to the control means via a further switching element. The further switching element allows division of the display elements into two or more groups.

In an embodiment as specified in claim 19, the display device has touchscreen functionality for controlling the apparatus.

An advantage of this embodiment is that physical buttons for controlling the apparatus according to this embodiment of the invention can be omitted, since user can interact with the apparatus by means of the touch-screen.

These and other aspects of the invention are apparent from and will be elucidated with reference to the embodiments described hereinafter.

In the drawings:

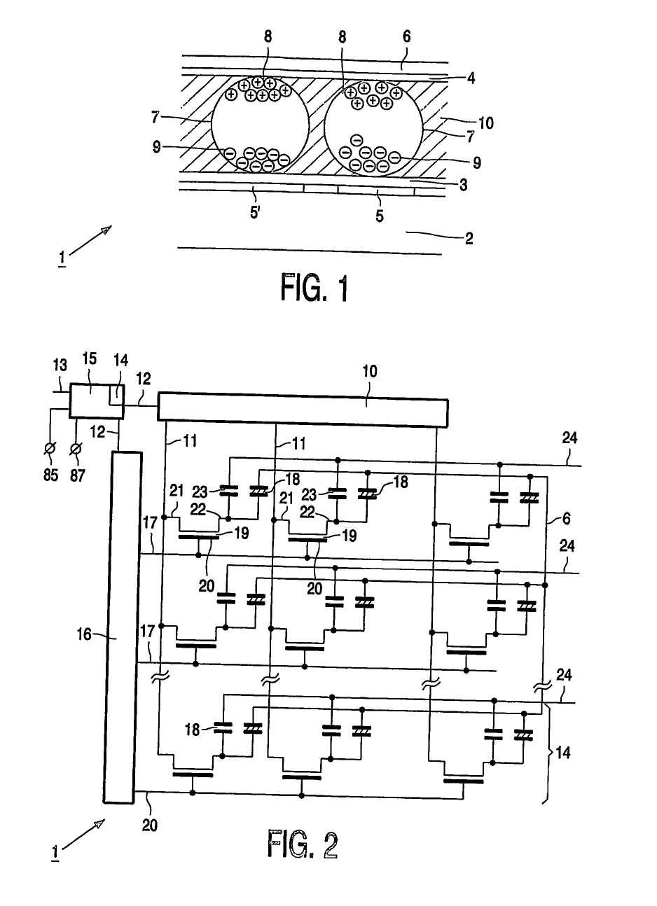

FIG. 1 is a diagrammatic cross-section of a portion of a display device,

FIG. 2 shows diagrammatically an equivalent circuit diagram of a portion of a display device,

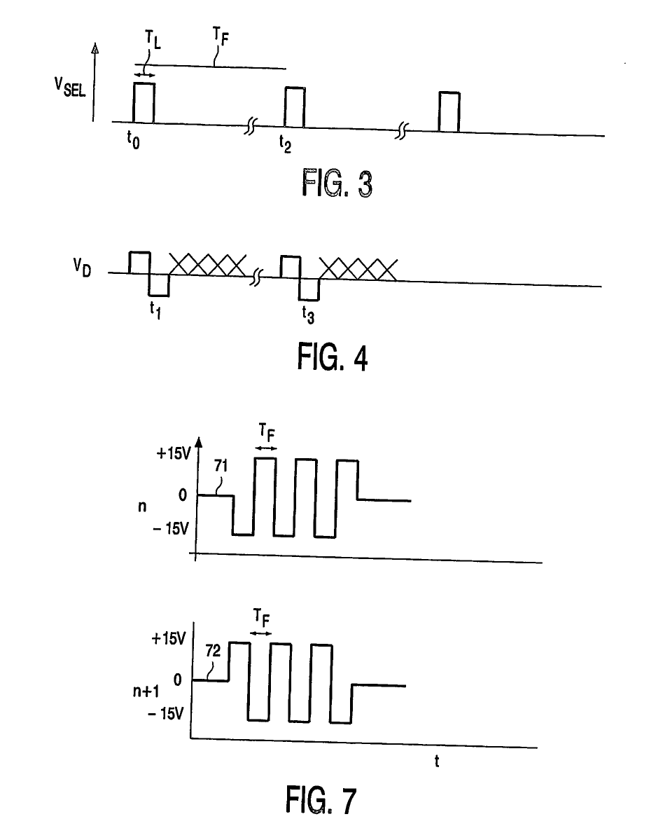

FIGS. 3 and 4 show drive signals and internal signals of the display device,

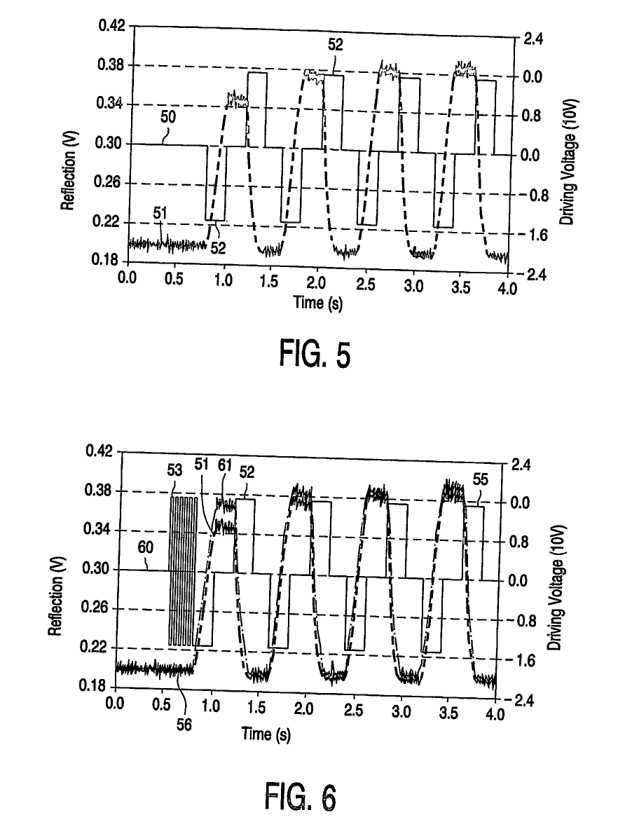

FIG. 5 shows an optical response of a data signal,

FIG. 6 shows an optical response of a preset signal and a data signal,

FIG. 7 shows preset signals for pixel electrodes for two adjacent rows consisting of 6 pulses of opposite polarities,

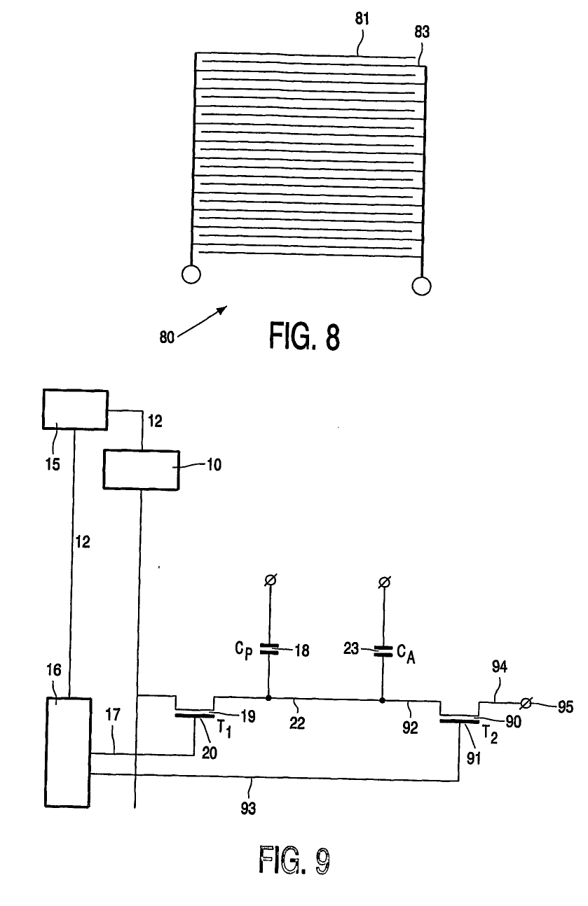

FIG. 8 shows an example of a counter electrode comprising interdigitized comb structures,

FIG. 9 shows an equivalent circuit of a display element with two TFTs, and

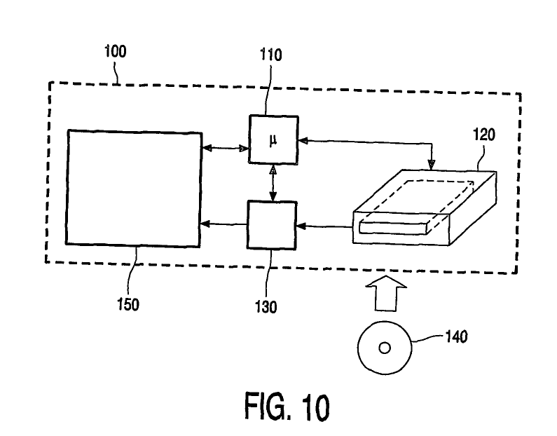

FIG. 10 shows an embodiment of the apparatus according to the invention.

The Figures are schematic and not drawn to scale, and, in general, like reference numerals refer to like parts.

FIG. 1 is a diagrammatic cross-section of a portion of an electrophoretic display device 1, for example of the size of a few display elements, comprising a base substrate 2, an electrophoretic film with an electronic ink which is present between two transparent substrates 3,4 of, for example, polyethylene, while one of the substrates 3 is provided with transparent picture electrodes 5 and the other substrate 4 is provided with a transparent counter electrode 6. The electronic ink comprises multiple microcapsules 7 of about 10 to 50 microns. Each microcapsule 7 comprises positively charged white particles 8 and negatively charged black particles 9 suspended in a fluid 10. When a negative field is applied to the counter electrode 6, the white particles 8 move to the side of the microcapsule 7 directed to the counter electrode 6, and the display element becomes visible to a viewer. Simultaneously, the black particles 9 move to the opposite side of the microcapsule 7 where they are hidden from the viewer. By applying a positive field to the counter electrodes 6, the black particles 9 move to the side of the microcapsule 7 directed to the counter electrode 6, and the display element becomes dark to a viewer (not shown). When the electric field is removed, the particles 8, 9 remain in the acquired state and the display exhibits a bi-stable character and consumes substantially no power.

FIG. 2 shows diagrammatically an equivalent circuit of a picture display device 1 comprising an electrophoretic film laminated on a base substrate 2 provided with active switching elements, a row driver 16 and a column driver 10. Preferably, a counter electrode 6 is provided on the film comprising the encapsulated electrophoretic ink, but could be alternatively provided on a base substrate in the case of operations using in-plane electric fields. The display device 1 is driven by active switching elements, in this example thin-film transistors 19. It comprises a matrix of display elements at the area of crossings of row or selection electrodes 17 and column or data electrodes 11. The row driver 16 consecutively selects the row electrodes 17, while a column driver 10 supplies a data signal to the column electrode 11. Preferably, a processor 15 first processes incoming data 13 into the data signals. Mutual synchronization between the column driver 10 and the row driver 16 takes place via drive lines 12. Select signals from the row driver 16 select the pixel electrodes 22 via the thin-film transistors 19 whose gate electrodes 20 are electrically connected to the row electrodes 17 and the source electrodes 21 are electrically connected to the column electrodes 11. A data signal present at the column electrode 11 is transferred to the pixel electrode 22 of the display element coupled to the drain electrode via the TFT. In the embodiment, the display device of FIG. 1 also comprises an additional capacitor 23 at the location of each display element 18. In this embodiment, the additional capacitor 23 is connected to one or more storage capacitor lines 24. Instead of TFTs, other switching elements can be applied such as diodes, MIMs, etc.

FIGS. 3 and 4 show drive signals of a conventional display device. At the instant t0, a row electrode 17 is energized by means of a selection signal Vsel (FIG. 1), while simultaneously data signals Vd are supplied to the column electrodes 11. After a line selection time tL has elapsed, a subsequent row electrode 17 is selected at the instant t1, etc. After some time, for example, a field time or frame time, usually 16.7 msec or 20 msec, said row electrode 17 is energized again at instant t2 by means of a selection signal Vsel, while simultaneously the data signals Vd are presented to the column electrode 11 in the case of an unchanged picture. After a selection time tL has elapsed, the next row electrode is selected at the instant t3. This is repeated from instant t4. Because of the bistable character of the display device, the electrophoretic particles remain in their selected state and the repetition of data signals can be halted after several frame times when the desired grey level is obtained. Usually, the image update time is several frames.

FIG. 5 shows a first signal 51 representing an optical response of a display element of the display device of FIG. 2 on a data signal 50 comprising pulses of alternating polarity after a dwell period of several seconds. In FIG. 5, the optical response 51 is indicated by - - - and the data signal by ______. Each pulse 52 of the data signal 50 has a duration of 200 ms and a voltage of alternating plus and minus 15 V. FIG. 5 shows that the optical response 51 after the first negative pulse 52 is not a desired grey level, which is obtained only after the third or fourth negative pulse.

In order to improve the accuracy of the desired grey level with the data signal, the processor 15 generates a single preset pulse or a series of preset pulses before the data pulses of the next refresh field, where the pulse time is typically 5 to 10 times less than the interval between an image update and a subsequent image update if the interval between two image updates is 200 ms. The duration of a preset pulse is typically 20 ms.

FIG. 6 shows the optical response of a data signal 60 of the display device of FIG. 2 as a response of a series of 12 preset pulses of 20 ms and data pulses of 200 ms having a voltage of alternating polarity of plus and minus 15 V. In FIG. 6, the optical response 51 is indicated by ----, the improved optical response 61 by -.-.-.-.- and the data signal by ____. The series of preset pulses consists of 12 pulses of alternating polarity. The voltage of each pulse is plus or minus 15 V. FIG. 6 shows a significant increase of the grey scale accuracy, while the optical response 61 is substantially at an equal level as the optical response after the fourth data pulse 55. However, some flicker introduced by the preset pulses may become visible, see optical response 56. In order to reduce the visibility of this flicker, the processor 15 and the row driver 16 can be arranged in such a way that the row electrodes 17 associated with display elements are interconnected in two groups, and the processor 15 and the column driver 10 are arranged to execute an inversion scheme by generating a first preset signal having a first phase to the first group of display elements and a second preset signal having a second phase to the second group of display elements, wherein the second phase is opposite to the first phase. Alternatively, multiple groups can be defined, to which end reset pulses are supplied with different phases. For example, the row electrodes 17 can be interconnected in two groups, one of the even rows and one group of the odd row, with the processor generating a first preset signal which consists of six preset pulses of alternating polarity of plus and minus 15 V, starting with a negative pulse to the display elements of the even rows, and a second preset signal which consists of six preset pulses of alternating polarity of plus and minus 15 V, starting with a positive pulse to display elements of the odd rows.

FIG. 7 shows two graphs which are indicative of an inversion scheme. A first graph 71 relates to a first preset signal consisting of 6 preset pulses of 20 ms supplied to a display element of an even row n, and a second graph 72 relates to a second preset signal consisting of 6 preset pulses of 20 ms supplied to a display element of an odd row n+1, wherein the phase of the second preset signal is opposite to the phase of the first preset signal. The voltage of the pulse alternates between plus and minus 15 V.

Instead of the series of preset pulses applied to two or more different groups of rows, the display elements can be divided into two groups of columns, for example, one group of even columns and one group of odd columns, wherein the processor 15 executes an inversion scheme by generating a first preset signal which consists of six preset pulses of alternating polarity of plus and minus 15 V, starting with a negative pulse to the display elements of the even columns, and a second preset signal which consists of six preset pulses of alternating polarity of plus and minus 15 V, starting with a positive pulse to the display elements of the odd columns. Here, all rows can be selected simultaneously. In further embodiments, inversion schemes as discussed hereinbefore can be simultaneously supplied to both rows and columns to generate a so-called dot-inversion scheme, which still further reduces optical flicker.

In a further embodiment, the counter electrode 80 is shaped as two interdigitized comb structures 81,83 as shown in FIG. 8 in order to reduce optical flicker. This kind of electrode is well known to the skilled person. The two counter electrodes 81,83 are coupled to two outputs 85,87 of the processor 15. Furthermore, the processor 15 is arranged to generate an inversion scheme by supplying a first preset signal which consists of six preset pulses of 20 ms of alternating polarity of plus and minus 15 V, starting with a negative pulse to the first comb structure 81, and a second preset signal which consists of six preset pulses of 20 ms of alternating polarity of plus and minus 15 V, starting with a positive pulse to the second comb structure 83, while holding the pixel electrode 23 at 0 V. After the preset pulses have been supplied, the two comb structures 81,83 can be connected to each other before new data is supplied to the display device.

In a further embodiment, the preset pulses can be applied by the processor 15 via the additional storage capacitors 23 by charge-sharing between the additional storage capacitor 23 and the pixel capacitance 18. In this embodiment, the storage capacitors on a row of display elements are connected to each other via a storage capacitor line, and the row driver 16 is arranged to interconnect these storage capacitor lines to each other in two groups allowing inversion of the preset pulses over two groups, a first group related to even rows of display elements and a second group related to odd rows of display elements. In order to improve grey scale reproduction before new data is supplied to the display element, the row driver executes an inversion scheme by generating a first preset signal which consists of 6 preset pulses of alternating polarity to the first group, and a second preset signal which consists of 6 preset pulses of alternating polarity to the second group, wherein the phase of the second signal is opposite to the phase of the first signal. After the preset pulses have been supplied to the display elements, the storage capacitors can be grounded before the new data is supplied to the display elements.

In a further embodiment, the preset pulses can be applied directly to the pixel electrode 22 by the processor 15 via an additional thin-film transistor 90 coupled via its source 94 to a dedicated preset pulse line 95 as shown in FIG. 9. The drain 92 is coupled to the pixel electrode 22. The gate 91 is coupled via a separate preset pulse addressing line 93 to the row driver 16. The addressing TFT 19 must be non-conducting by, for example, setting the row electrode 17 to 0 V.

When the preset signal is applied to all display elements simultaneously, flicker may occur. Therefore, preset signal inversion is applied by division of the additional thin-film transistors 90 into two groups, one group connected to display elements of even rows and one group connected to display elements of odd rows. Both groups of TFTs 90 are separately addressable and connected to the preset pulse lines 95. The processor 15 executes an inversion scheme by generating a first preset signal which consists of, for example, 6 preset pulses of 20 ms and a voltage 15 V of alternating polarity to the first group of TFTs 90 via the preset pulse line 95, and a second preset signal which consists of 6 preset pulses of 20 ms and a voltage of 20 ms of alternating polarity to the second groups of TFTs 90, wherein the phase of the second signal is opposite to the phase of the first signal. Alternatively, a single set of TFTs which are addressable in the same time can be attached to two separate preset pulse lines with inverted preset pulses.

After the preset signals have been supplied to the TFTs 90, the TFTs are deactivated before new data is supplied via the column drivers 10.

Furthermore, further power reductions are possible in the described embodiments by applying any of the well-known charge recycling techniques to the (inverted) preset pulse sequences to reduce the power used to charge and discharge pixel electrodes during the preset pulse cycles.

Because of its high brightness and high contrast ratio, a display device as described above is very suitable for presentation of text to a user. Furthermore, such a display is light weight and—as already mentioned—low-power, which makes it very suitable for portable applications like portable rendering of for example a textbook of which an image is stored in a memory. This application is known as an electronic book.

One of the most important features of a portable device are size and weight Therefore, the memory or disk drive comprised by the apparatus according to the invention should be small and light. Such devices are available as solid state memories. Problem is, however, that such memories are relatively expensive and can only carry relatively small amounts of data.

Currently harddisk drives are available with the size of a CompactFlash card. However, this type of drives is still relatively expensive compared to regular mass storage solutions like regular harddisk drives (3.5 inch, approximately 89 millimeters).

Cheap mass storage memories are available as optical disks such as the Compact Disc®. However, CD drives are rather large and heavy. Although portable CD-players are available, they are still too large to fit in every pocket of clothing. Presentation of a book in electronic format is preferably done on an electrophoretic display with a diagonal of 6 inches, about 15 centimeters. This yields a display of about 9 centimeters by 12 centimeters at the sides. Since the size of a CD is already 12 centimeters in diameter, the drive would take up even more space than the display, while the display is actually the most important part of the apparatus and the memory is mere overhead volume.

Therefore, it is advantageous to use a smaller disk drive for reading data from optical disks with a diameter of between 25 millimeters and 50 millimeters, preferably about 3 centimeters. The disks are preferably removable optical disks. Embodiments of such a small disk and disk drive have been disclosed on http://www.cd-rw.org. Currently, a prototype drive of 5.6×3.4×0.75 cubic centimeters is available for a disk with a diameter of 3 centimeters. A major advantage of such optical disks is that they provide a cheap distribution medium for prerecorded content, since these media can be produced very low-cost with low manufacturing effort. This also means, that copies can be easily made and distributed. This is in particular relevant for application of a disk drive for such disks in an electronic book.

Using blue laser for reading and/or writing data from or to the small optical disk, combined with a lens system with high numerical aperture for a small spot size, high data density can be reached (1 Gigabyte for a 3 cm diameter disk), yielding a low price per megabyte of storage space. This means that information on a small optical drive as presented can even be presented to consumers as a cheap disposable Read-Only Memory data carrier.

FIG. 10 shows an apparatus 100 as an embodiment of the apparatus according to the invention. The apparatus 100 comprises a disk drive 120 for receiving a small optical disk 140 and retrieving data therefrom, a video processor 130 for converting data retrieved from the small optical disk 140, a video processor 130 for converting data retrieved from the small optical disk 140, an elektrophoretic display device 150 for rendering the converted data and a central processing unit 110 for controlling the disk drive 120 and the video processor 130.

According to an embodiment of the invention, the electrophoretic display device 150 has touch screen functionality for controlling the apparatus 100. This solution for providing input means to control the apparatus 100 may be more expensive than providing merely a set of buttons, but decreases the size of the apparatus 100.

For browsing through books presented on the electrophoretic display 150, separate soft button may be displayed on the electrophoretic display 150 are provided in one embodiment of the apparatus according to the invention. In a further embodiment of the apparatus according to the invention, a user is enabled to browse through the pages of a book using dedicated user commands like tapping twice on the screen; once in the middle and once on the right half of the electrophoretic display 150 for browsing forward and once in the middle and once on the left half of the electrophoretic display 150 for browsing backward through the book. For transfer of user control input signals, the electrophoretic display 150 is coupled to the central processing unit 110.

The dimensions mentioned are preferred by the inventors, but merely illustrative of the more general idea of the invention; persons skilled in the art will readily appreciate that deviation from the embodiments described is possible without departing from the scope of the invention.

1. A method of caching a part of digital content data from a content source (202), comprising the step of:
acquiring the digital content data from the content source (202),
characterized in that
said part of the digital content data comprises interleaved segments (130; 131) of the acquired digital content data, and
said interleaved segments (130; 131) of the acquired digital content data are stored in a first memory (203), thereby allowing for fast access to said part of the digital content data.

2. A method according to claim 1, wherein the digital content data are digital audio and/or video data.

3. A method according to claim 1, characterized in that the method further comprises playing back the digital content data stored on the content source (202), and that the storing of said interleaved segments (130; 131) takes place at or after replay.

4. A method according to claim 1, characterized in that the storing of the interleaved segments (130; 131) depends on parameters, which at least take account for a probability of replay and/or an acquisition time.

5. A method according to claim 1, characterized in that the digital content data are video data in MPEG format and that the interleaved segments of the acquired digital content data are I-pictures.

6. A method according to claim 1, characterized in that each of the interleaved segments (130; 131) of the acquired digital content data is a continuously acquired part of the digital content data from the content source (202).

7. A method according to any of the claim 1, characterized in that the method further comprises storing a contiguous first part of the digital content data in a second memory (204), which contiguous part (121) of the digital content data is suitable for use as anti-shock buffer data.

8. A method according to any of the claim 7, characterized in that the first memory (203) and the second memory (204) are comprised in a single memory circuit (205).

9. A method according to claim 1, wherein the content source (202) is a storage medium.

10. A method according to claim 1, wherein the content source (202) is a remote source and wherein the acquisition of the digital content data comprises receiving the digital content data over a network.

11. A device for caching a part of digital content data from a content source, comprising means for acquiring the digital content data from the content source,
characterized in that
the device (200) further comprises first memory (203) arranged to store interleaved segments (130; 131) of the acquired digital data, thereby allowing for fast access to said part of digital content data.

12. A device according to claim 11, wherein the digital content data are digital audio and/or video data.

13. A device according to claim 11, characterized in that the device further comprises means for playing back (207) the digital content data stored on the first memory (203), and the first memory (203) is adapted to store said interleaved segments (130; 131) at or after replay.

14. A device according to claim 11, characterized in that the device further comprises decision means (201), which are arranged to, in dependence on parameters taking account for a probability of replay and/or an acquisition time, decide which part of the digital content data is to be stored.

15. A device according to any of the claim 11 to 14, characterized in that the digital content data are video data in MPEG format and that the interleaved segments of the acquired digital content data are I-pictures.

16. A device according to claim 11, characterized in that each of the interleaved segments (130; 131) of the acquired digital content data is a continuously acquired part of the digital content data from the content source (202).

17. A device according to claim 11, characterized in that the device (200) further comprises a second memory (204) suitable as an anti-shock buffer, which second memory (204) are adapted for storing of a contiguous part (121) of the digital content data, which contiguous part (121) of the digital content data is suitable for use as anti-shock buffer data.

18. A device according to claim 17, characterized in that the first memory (203) and the second memory (204) are comprised in a single memory circuit (205).

19. A device according to claim 11, wherein the content source (202) is a storage medium.

20. A device according to claim 11, wherein the content source (202) is a remote source, and wherein the means for acquiring the digital content data comprises means for receiving data over a network.
